(19) United States
(12) Patent Application Publication
(10) Pub. No.: US 2025/0333657 A1
(43) Pub. Date: Oct. 30, 2025

(54) HEATER ARRANGEMENT FOR ELECTRICALLY CRACKING HYDROCARBON FEEDS FOR OLEFIN PRODUCTION

(71) Applicant: Lummus Technology LLC, Houston, TX (US)

(72) Inventor: Kandasamy M. Sundaram, Houston, TX (US)

(73) Assignee: Lummus Technology LLC, Houston, TX (US)

(21) Appl. No.: 19/188,568

(22) Filed: Apr. 24, 2025

Related U.S. Application Data
(60) Provisional application No. 63/639,505, filed on Apr. 26, 2024.

(51) Int. Cl. C10G 9/26; B01J 6/00

(52) U.S. Cl. CPC C10G 9/26; B01J 6/00

(57) ABSTRACT

Processes and systems for converting a hydrocarbon mixture to produce olefins. The process and systems include preheating a hydrocarbon feed in one or multiple preheaters to a preheat temperature, producing a preheated hydrocarbon stream. The preheated hydrocarbon stream are separated in one or more separation systems, producing a vaporized hydrocarbon stream and a liquid hydrocarbon stream. The vaporized hydrocarbon stream is heated in a secondary transfer line exchanger, producing a heated hydrocarbon stream that is further heated in a convective electric preheater, producing a second heated hydrocarbon stream. The second heated hydrocarbon stream is then cracked, using a radiant electric thermal cracking heater, producing a cracked hydrocarbon product stream, which is fed to a primary transfer line exchanger for quenching the cracked hydrocarbon product stream and recovering a cooled hydrocarbon product stream. The cooled hydrocarbon product stream is then fed to the secondary transfer line exchanger, producing a hydrocarbon product.

### FIELD OF THE DISCLOSURE

Embodiments of the present disclosure generally relate to an electrically heated furnace to produce bulk chemicals such as ethylene, propylene and butadiene as well as aromatics and other products (product gas) from a hydrocarbon feedstock (feed gas) at large scale.

### BACKGROUND

Various flow schemes have been proposed for the use of electricity to heat and crack hydrocarbon feeds. Unfortunately, heat recovery from the product cracked hydrocarbons is inefficient and variable, especially when cracking heavy hydrocarbon feedstocks that contain coke precursors. Heating the heavy hydrocarbon feed by recovering heat from the cracked product, such as in a primary or secondary transfer line exchanger, can result in significant fouling, and hence a high variability in the temperature of the heated feed over the length of a run (operational time between startup and shutdown for routine maintenance, decoking, etc.).

Accounting for the wide swings in preheated feed temperature to an electric cracking furnace results in the need for multiple transformers and associated electrical equipment to handle the current loads needed for the cracking process over the length of a run. This adds additional capital expense and operating cost to the overall electric cracking system. For example, a single transformer may provide 5 to 6 MW, while a single coil producing 20 to 30 kilotons of ethylene per coil may require 8 to 12 MW energy. This results in the need for two to three transformers per heater, and is thus economically unfavorable.

### SUMMARY OF THE CLAIMED EMBODIMENTS

Embodiments disclosed herein provide for staged heating to achieve a desired and relatively constant crossover temperature (cracking heater inlet temperature) over the length of a run (relatively constant used in this context refers to an operational steady state having some fluctuation around a set point, as would be understood by one skilled in the art).

In one aspect, embodiments disclosed herein relate to a process for converting a hydrocarbon mixture to produce olefins. The process includes preheating a hydrocarbon feed in one or multiple preheaters to a preheat temperature, producing a preheated hydrocarbon stream. The preheated hydrocarbon stream are separated in one or more separation systems, producing a vaporized hydrocarbon stream and a liquid hydrocarbon stream. The vaporized hydrocarbon stream is heated in a secondary transfer line exchanger, producing a heated hydrocarbon stream. The heated hydrocarbon stream is further heated in a convective electric preheater, producing a second heated hydrocarbon stream. The second heated hydrocarbon stream is then cracked, using a radiant electric thermal cracking heater, producing a cracked hydrocarbon product stream, and the cracked hydrocarbon product stream is fed to a primary transfer line exchanger for quenching the cracked hydrocarbon product stream and recovering a cooled hydrocarbon product stream. The cooled hydrocarbon product stream is then fed to the secondary transfer line exchanger, producing a hydrocarbon product stream.

In another aspect, embodiments disclosed herein relate to a process for converting a hydrocarbon mixture to produce olefins. The process includes preheating a hydrocarbon feed [via indirect heat exchange with boiler feed water, steam, or other sources of heat located in the plant] in one or multiple first preheaters to a preheat temperature, producing a preheated hydrocarbon stream. The preheated hydrocarbon stream is then mixed with dilution steam to produce a mixture, which is heated in one or multiple second preheaters, producing a heated hydrocarbon-steam mixture. The heated hydrocarbon-steam mixture is further heated in a convective electric preheater, producing a second heated hydrocarbon stream. The second heated hydrocarbon stream is then cracked using a radiant electric thermal cracking heater, producing a cracked hydrocarbon product stream, and the cracked hydrocarbon product stream is fed to a primary transfer line exchanger for quenching the cracked hydrocarbon product stream and recovering a cooled hydrocarbon product stream.

In another aspect, embodiments disclosed herein relate to a system for converting a hydrocarbon mixture to produce olefins. The system includes a first preheat system comprising one or multiple preheaters configured to receive and preheat a hydrocarbon feed to a preheat temperature, and to output a preheated hydrocarbon stream. A separation system is provided for separating the preheated hydrocarbon stream to recover a vaporized hydrocarbon stream and a liquid hydrocarbon stream. The system also includes a secondary transfer line exchanger for heating the vaporized hydrocarbon stream to produce a heated hydrocarbon stream. A convective electric preheater is provided for heating the heated hydrocarbon stream to produce a second heated hydrocarbon stream, and a radiant electric thermal cracking heater is configured for heating and cracking the second heated hydrocarbon stream to produce a cracked hydrocarbon product stream. The system further includes a primary transfer line exchanger for quenching the cracked hydrocarbon product stream to recover a cooled hydrocarbon product stream, and a flow line for feeding the cooled hydrocarbon product stream to the secondary transfer line exchanger, producing a hydrocarbon product stream.

In yet another aspect, embodiments disclosed herein relate to a system for converting a hydrocarbon mixture to produce olefins. The system includes a first preheat exchanger system comprising one or multiple heat exchangers to heat a hydrocarbon feedstock to a preheat temperature, producing a preheated hydrocarbon stream. One or more flow lines are provided for mixing the preheated hydrocarbon stream with dilution steam to produce a mixture. A second preheat exchanger system, including one or multiple heat exchangers to heat the mixture, is provided to produce a heated hydrocarbon-steam mixture. Further, the system includes a convective electric preheater for heating the heated hydrocarbon-steam mixture, producing a second heated hydrocarbon stream, and a radiant electric thermal cracking heater for cracking the second heated hydrocarbon stream, producing a cracked hydrocarbon product stream. Additionally, the system includes a primary transfer line exchanger for quenching the cracked hydrocarbon product stream and recovering a cooled hydrocarbon product stream.

Other aspects and advantages will be apparent from the following description and the appended claims.

### BRIEF DESCRIPTION OF DRAWINGS

FIGS. 1, 1A, 2, and 3 illustrate simplified process flow diagrams of systems for cracking hydrocarbons according to one or more embodiments disclosed herein.

FIG. 4 illustrates boiling curves for various hydrocarbon feedstocks that may be used in embodiments herein.

### DETAILED DESCRIPTION

One way to reduce or even eliminate emissions from large-scale production of olefins is electrification of the energy source, preferably where the electricity is supplied by renewable energy. Embodiments herein relate to systems that include electric furnaces (electric cracking heaters) for the production of petrochemicals, such as ethylene, propylene, and butadiene, as well as aromatics and other products for downstream processes. More specifically, embodiments herein are directed toward electrically heated furnaces to produce bulk chemicals such as ethylene, propylene and butadiene as well as aromatics and other products (product gas) from a hydrocarbon feedstock (feed gas) at large scale. Rather than relying on burning fossil fuels for the required energy input, embodiments herein provide a furnace that employs electrical heating of reaction coils (cracking coils) for conversion of heavier hydrocarbons to the desired products.

Cracking systems herein include a preheat system for preheating the hydrocarbon feedstock, or a hydrocarbon-steam mixture, to a preheat temperature. Cracking systems herein further include a convective electric heater (the crossover electric heater) for further heating the preheated hydrocarbon feedstock to a desired cracking heater inlet temperature (also referred to herein as a crossover temperature). Systems herein further include a cracking heater, receiving a heated hydrocarbon feedstock, the cracking heater further heating the hydrocarbon feedstock to cracking temperatures, producing a cracked hydrocarbon product. Systems herein also include a primary transfer line exchanger, in which the cracked hydrocarbon product is rapidly quenched to a temperature below the reaction temperature, i.e., cooled from reaction temperature to a temperature of less than 700° C., such as in the range 550-680° C. The quenched cracked product is then fed to a secondary transfer line exchanger for additional heat recovery, producing a cooled cracked hydrocarbon product stream.

Processes and systems herein utilize relatively low temperature streams for initial preheating of the hydrocarbon feedstocks to a preheat temperature. This energy may be provided by steam, quench water, boiler feed water, heat transfer fluids, or other various low energy streams available in the plant.

The energy added to the hydrocarbon feedstock via the one or multiple heat exchangers in the preheat system may, depending upon feed type, vaporize, partially vaporize, or simply heat the hydrocarbon feedstock. Ethane, propane, and butane may be fully vaporized during this initial preheat stage and may thus be fed to the crossover heater for heating to a desired crossover temperature or may be fed directly to the cracking heater. For feeds that are only partially vaporized in the preheat system (such as naphtha and other atmospheric distillate range hydrocarbons) may be further heated, such as in additional preheaters or via heat exchange with the cracked hydrocarbon effluent in the secondary transfer line exchanger.

If needed, and as typically needed for heavier feedstocks (gas oils and other heavier vacuum distillate range hydrocarbons or a whole crude) following the initial preheating, the preheated hydrocarbon feedstock will then be heated to a higher temperature, closer to that of the desired crossover temperature (cracking heater feed inlet temperature). Such heating is conducted via indirect heat exchange with the quenched cracked product stream in a secondary transfer line exchanger, or using steam generated in the secondary transfer line exchanger. Depending upon the hydrocarbon feed type (light, medium, heavy) and the amount of coke precursors contained in the hydrocarbon feed, a partially vaporized hydrocarbon feedstock may be separated into a liquid phase and a vapor phase, such that the vapor phase may be further heated in the secondary transfer line exchanger. Naphtha is considered as light feed herein. Gasoil and HVGO (hydrocracked vacuum gas oil) are considered as heavy feeds. Condensates (and crude) start boiling at low temperature like naphtha and ends up like vacuum gas oil and is termed as heavy feed in this document.

Following heating of the hydrocarbon feedstock in the secondary transfer line exchanger or in a heating system using steam from the secondary transfer line exchanger, the preheated hydrocarbon feed may then be further heated in the crossover electric heater to a desired crossover temperature and then fed to the cracking heater for conversion at cracking temperatures to lighter hydrocarbons.

Systems herein may be designed for a singular type of feed (light, medium, or heavy), or may be configured to accept multiple types of hydrocarbon feedstocks (light, medium, and heavy). For those systems processing multiple types of hydrocarbon feedstocks, the amount of heat input required may vary, and thus bypasses around one or multiple of the preheat system(s), the secondary transfer line exchanger, and the crossover heater may be provided so that the desired or appropriate cracking heater inlet temperature may be provided for the respective feed type, and for selective processing of the feeds to avoid fouling of the secondary transfer line exchanger.

Preheat systems, such as those using quench water, boiler feed water, and various steam streams may be used to heat a hydrocarbon feedstock to a temperature in a range from about 250° C. to about 400° C., such as in a range from about 280° C. to about 330° C. Low temperature heating can be provided by quench water, boiler feed water or by other hot fluids available in the plant. Further heating may then be done by steam, such as low- pressure steam, medium pressure steam, high pressure steam, super high-pressure steam, or hot heat exchange fluids (DOWTHERM and the like, for example). The saturation temperature of super high-pressure steam is typically in a range of 315° C. to 330° C., and heat exchange fluids also have a maximum operating temperature so as to avoid decomposition, such as around 400° C., and thus the temperature to which the hydrocarbon feedstock may be heated in the preheat systems is accordingly also limited.

Heating of the hydrocarbon feedstock in the secondary transfer line exchanger may be used to increase a temperature of the preheated feedstock to a temperature in a range from about 350° C. to about 650° C., such as in a range from about 350° C. to about 500° C. The amount of heat extracted in the secondary transfer line exchanger should be targeted to 10° C. to 50° C. below the desired crossover temperature, noting that lighter feeds have a higher crossover temperature than heavier feeds (onset of cracking occurs at lower temperatures for heavier feeds and higher temperatures for lighter feeds). The feed may be heated above 550° C., above 600° C., or even as high as 635° C. prior to being fed to the crossover heater.

To maintain consistency of operations over the length of a run, the preheated feedstock is then fed to the crossover heater for further heating from the preheat temperature to the crossover temperature appropriate for the feedstock being processed. Heavier feeds may be heated to a crossover temperature, for example, in a range from 570° C. to 630° C., while lighter feeds may be heated to a crossover temperature in a range from 650° C. to 700° C. Crossover temperatures may thus encompass a range, for example, from about 570° C. to 700° C., noting that for most feeds the crossover temperature may be around 600° C.

Controlling the preheating as described herein segregates the radiant cracking heater from other electrical heating. Further, the use of separate preheating provides for a high degree of flexibility and control for the entire cracking process. Preheating as described herein may thus provide for consistent performance over the length of a run, regardless of the feed type or change of feeds during a run.

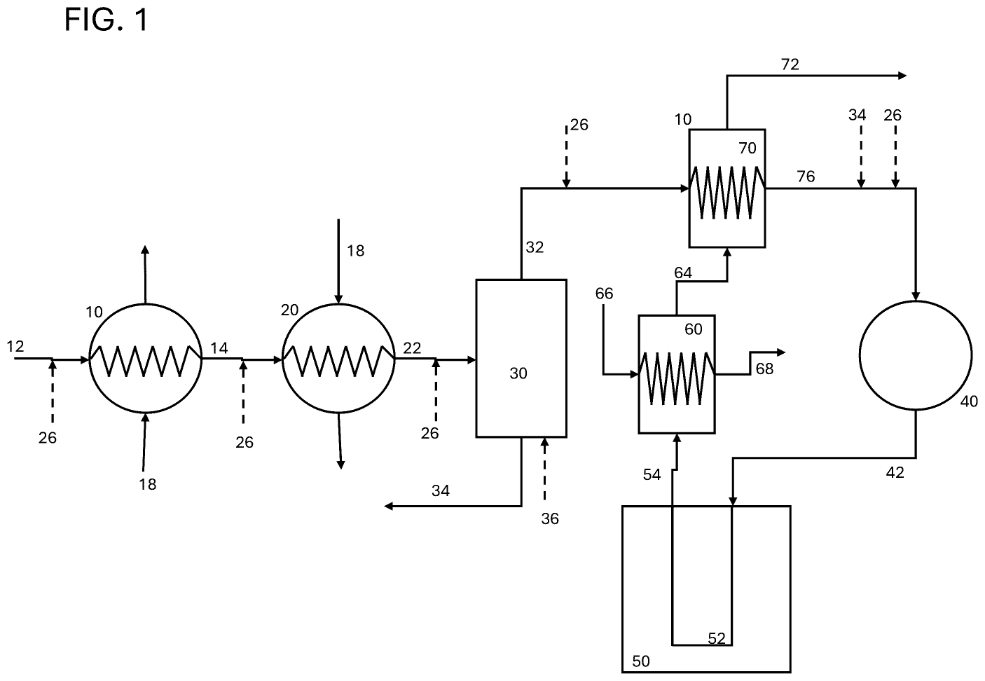

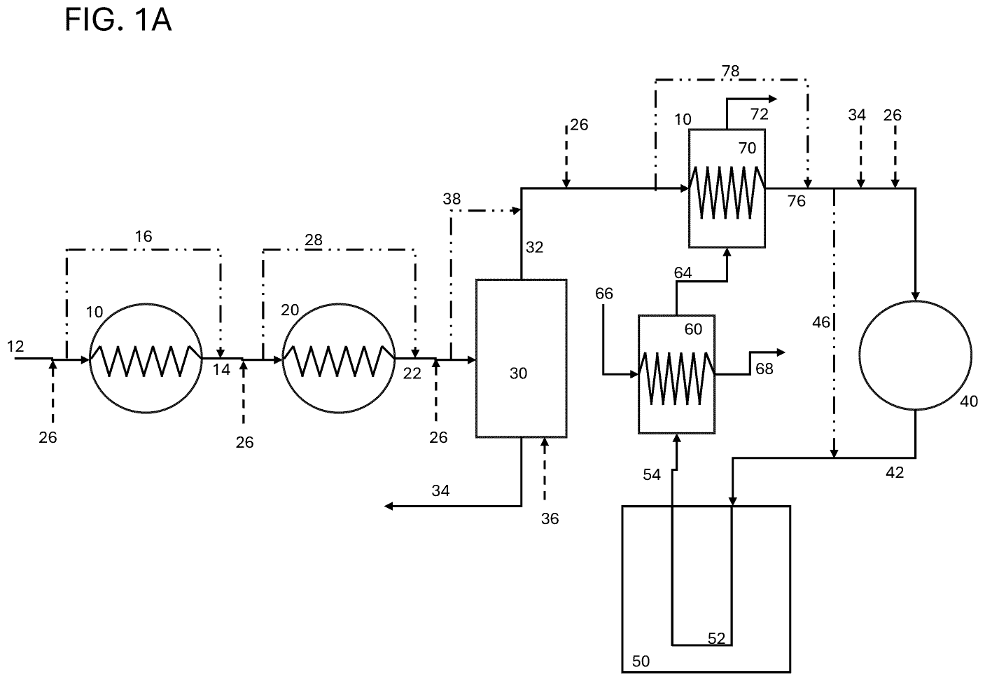

Referring now to FIG. 1, a simplified process flow diagram of systems for cracking hydrocarbons according to one or more embodiments disclosed herein is illustrated. The system of FIG. 1 includes a first heat exchange system 10, a second heat exchange system 20, a separator 30, an electric crossover exchanger 40, a radiant electric cracking heater 50, a primary transfer line exchanger 60, and a secondary transfer line exchanger 70. Each exchanger system may include one or multiple heat exchangers and may use the same or different heating fluids in parallel or series.

A hydrocarbon feedstock 12 is fed to first exchanger system 10 and heated from feed temperature to a first temperature, producing a first preheated hydrocarbon stream 14. The hydrocarbon feedstock may then be further heated in second heat exchange system 20, producing preheated hydrocarbon stream 22. Heating of the hydrocarbon feedstock may be performed via indirect heat exchange with boiler feed water, steam, or other sources of heat located in the plant, the heat sources generally denoted as reference numeral 18 in the Figures.

Upstream, intermediate, or downstream of first and second heat exchange systems 10, 20, the hydrocarbon feedstock may be mixed with dilution steam 26. The amount, pressure, and temperature of dilution steam and the location(s) of dilution steam addition may depend upon the hydrocarbon feedstock being processed.

The preheated hydrocarbon feedstock 22 may be partially vaporized following the heat addition provided by exchanger systems 10, 20. The partially vaporized hydrocarbon feedstock may then be fed to a separator 30 to separate the vaporized hydrocarbons 32 from the un-vaporized hydrocarbons 34. Additional dilution steam 36 may be added to separator 30 if desired. Separator 30 may be a single stage flash system or a multi-stage separation system, and may include demister pads and an optional reflux (not illustrated) to minimize liquid droplet carryover into vapor stream 32.

The resulting vapor stream 32 may be further diluted with dilution steam 26, if desired. The vapor mixture is then be fed to secondary transfer line exchanger 70, further heating the hydrocarbon feedstock and recovering heat from the cracked effluent 64. The resulting heated hydrocarbon stream 76 may optionally be further diluted with steam 26. Further, if it is desired to crack the liquid 34 recovered from the separator, such may be re-combined with the heated vapor 76 downstream of the secondary transfer line exchanger 70; bypass of the liquid around the transfer line exchanger prevents rapid fouling of the secondary transfer line exchanger as might otherwise occur.

Heat recovery from the secondary transfer line exchanger may result in heated hydrocarbon stream 76 having at a temperature close to, but still below, a desired crossover temperature (below the desired cracking heater inlet temperature). To provide a desired and constant cracking heater inlet temperature, heated hydrocarbon stream may be fed to a convective electric preheater 40, heated electrically, producing heated hydrocarbon stream 42 having an appropriate crossover temperature.

The heated hydrocarbon stream 42 at the crossover temperature is then fed to an electric cracking heater 50, wherein the hydrocarbon is further heated in cracking coil 52 to cracking temperatures, cracking hydrocarbons in the feedstock to produce ethylene, propylene, butenes, butadienes, aromatics, and other cracked hydrocarbons. The resulting cracked effluent 54 is then rapidly cooled in primary transfer line exchanger 60, producing a cooled hydrocarbon product stream 64. Quench of the reaction may be performed by heating a water or steam stream 66 to produce a superheated steam stream 68, which may be used to provide dilution steam 26, 36 or as a heat source 18 within the heat exchange systems 10, 20.

Cooled (quenched) hydrocarbon product stream has sufficient heat available, and is fed to secondary transfer line exchanger 70 for heating of the vaporous hydrocarbon feedstock 32, as described above, resulting in a further cooled hydrocarbon product stream 72, which may then be fed to downstream heat recovery and separation systems (not illustrated) to recover the desired hydrocarbon product fractions (ethylene, propylene, butadiene, aromatics, etc.).

To provide flexibility to the process, bypasses around various units may be provided, as illustrated in FIG. 1A, where like numerals represent like parts. A light or medium hydrocarbon feedstock 12 may not require the same amount of heating to partially or fully vaporize the hydrocarbons as may be required for a heavy hydrocarbon feedstock. Accordingly, bypasses 16, 28 may be provided to bypass one or both of heat exchange systems 10, 20. A fully vaporized hydrocarbon feedstock may also bypass separator 30 via flow line 38. Where preheating of the feedstock is sufficient to approach desired crossover temperatures, where it is desired to avoid fouling of the secondary transfer line exchanger, bypasses 78, 46 may be used. Such bypasses are optional, providing flexibility in unit operations for accommodating various hydrocarbon feedstocks, but are not necessary in all embodiments, such as for a system where only a single type of feed is to be processed.

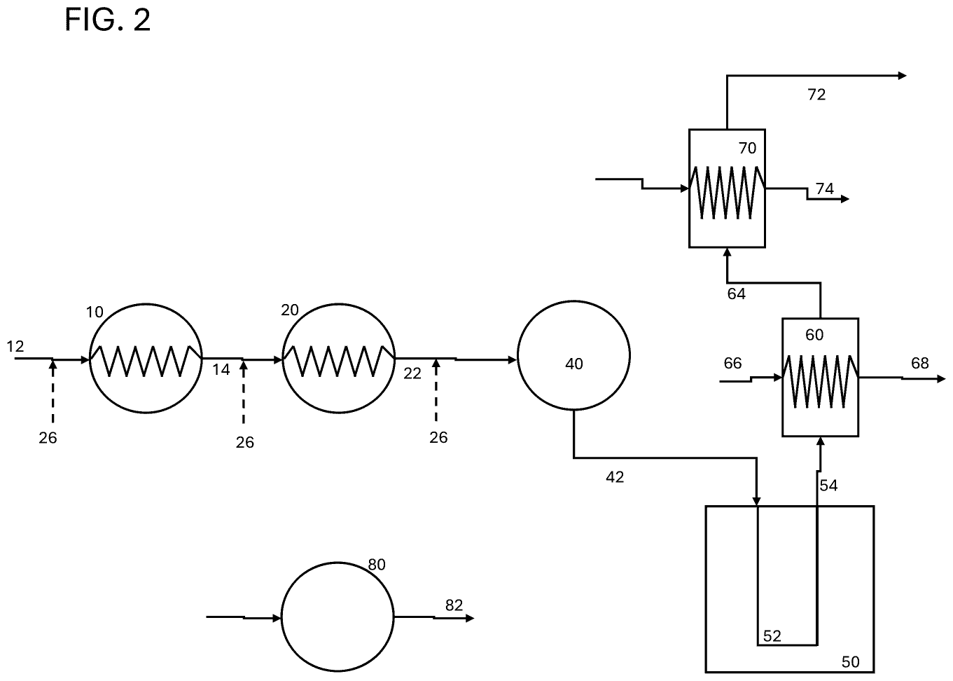

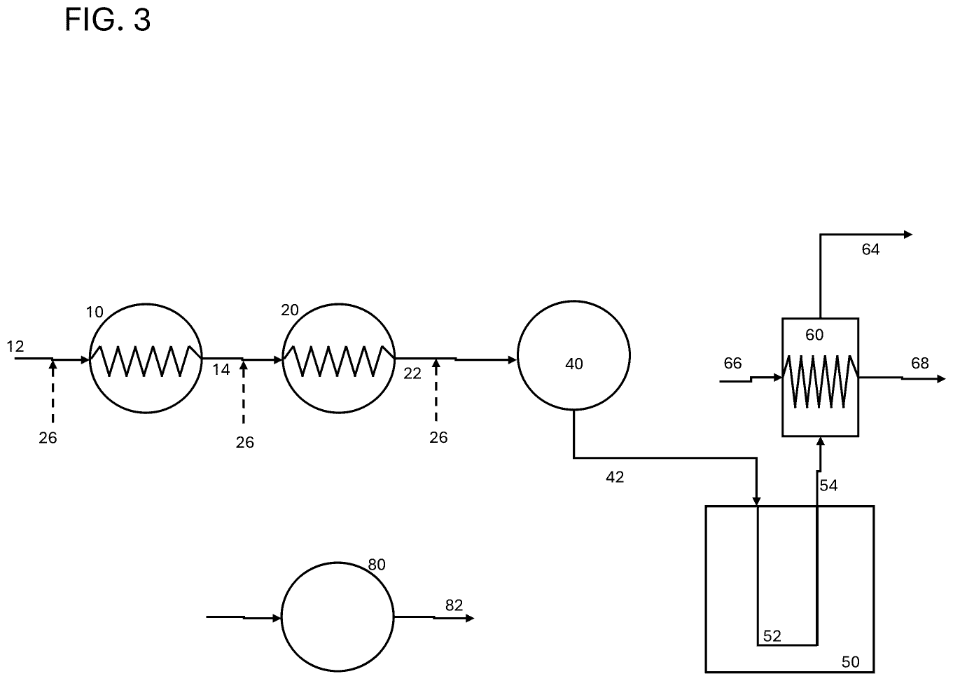

Referring now to FIG. 2, a scheme without separation of the partially vaporized hydrocarbon feed is illustrated. Like numerals represent like parts. In this embodiment, the preheated hydrocarbon feedstock 22 is fed to electric crossover heater 40, which may be designed for single phase or multi-phase heating of the hydrocarbon feedstock to desired crossover temperatures, as may be appropriate for the expected feeds to be processed. In this embodiment, secondary transfer line exchanger 70 may be used to produce additional steam 74, for example. If necessary for heat balance of the system, an additional steam superheater 80 may also be provided, and the resulting steam 82 may be used as dilution steam 26 or as a heat exchange medium 18 in exchanger systems 10, 20. As illustrated in FIG. 3, some embodiments may not include a secondary transfer line exchanger.

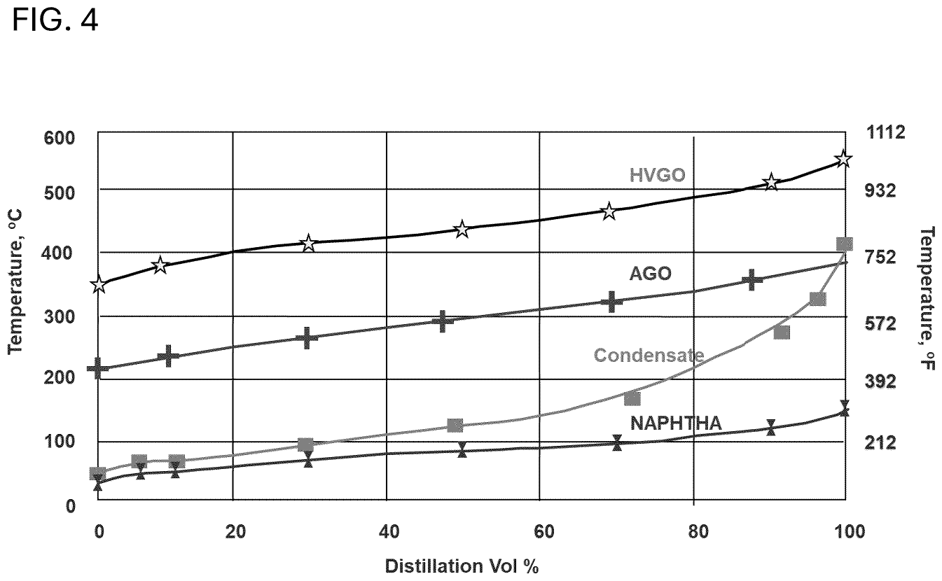

As described with embodiments herein, in a secondary transfer line exchanger, feed hydrocarbon with or without dilution steam is mixed and heated. As the secondary transfer line exchanger inlet temperature is hot, preheating raises the hydrocarbon feed plus dilution steam (usually in the secondary side) to reasonably high temperature that is reasonably close to the crossover temperature experienced in fired heaters. Therefore, additional heating is not always required, and such mixtures can be sent to radiant coil for cracking. With fouling of secondary transfer line exchanger, energy recovered in the secondary transfer line exchanger is reduced during a cracking cycle and hence crossover temperature (inlet temperature to radiant coil) is reduced. In addition, only light feeds like ethane, propane can be used in the secondary transfer line exchanger without significant fouling. Naphtha may foul a secondary transfer line exchanger, but the run length before cleaning is reasonable (months) and the loss of secondary transfer line exchanger duty due to fouling is small. However, when heavy feeds like gasoil, condensates, crude are used, they can foul in a matter of days. So only dilution steam can be superheated in the secondary transfer line exchanger. With only dilution steam, high cross over temperature can't be achieved. This compromises the radiant coil performance. Boiling curves of different liquid feeds are shown in FIG. 4. Naphtha is considered as light feed. Gasoil and HVGO (hydrocracked vacuum gas oil) are considered as heavy feeds. Condensates (and crude) starts boiling at low temperature like naphtha and ends up like vacuum gas oil and is termed as heavy feed in this document.

With heavy feeds, transfer line exchanger fouling is excessive and hence a secondary transfer line exchanger cannot be used to preheat such heavy hydrocarbon feeds economically. With fouling, energy recovery in that exchanger is reduced. Therefore, achievable crossover temperature is also reduced. Thus, for heavy feeds, either dilution steam is superheated in secondary transfer line exchanger or no secondary transfer line exchanger is used while generating maximum amount of super high-pressure steam in the primary transfer line exchanger. Hydrocarbon feeds are preheated and partially or fully vaporized externally in exchangers and mixed with dilution steam. The mixture is further superheated electrically with heaters upstream of the radiant cell. Desired and constant cross over temperature can be obtained for any feed and any operating conditions. This gives constant crossover temperature to the radiant coils and hence performance of radiant box remains nearly the same from start-of-run to end-of-run. Radiant duty also remains nearly constant from start-of-run to end-of-run.

As described herein, a few options are described to address fouling and run consistency issues. For all options, a small electric preheater will be used immediately upstream of the radiant electric cracking heater to control crossover temperature. In the radiant section preheating the feed is not preferred since the radiant box is too hot and can cause severe coking. It is also not optimum in electric power usage. Preheating a specific feed like naphtha or gasoil can be common to all heaters and hence common preheaters can be used in the plant. There is no issue at all when one electric preheater is used for every coil or for every few coils or for every heater or for every few heaters. The outlet temperature of the preheater is determined by the type of feed that is being cracked. For example, for ethane it can be as high as 700° C. However, for gas oil more than 600° C. is not preferred; otherwise, coke deposition can occur in the preheater and the lines leading to the radiant coils. The crossover temperature can be precisely controlled by this electric preheater. However, total hydrocarbon duty is dictated by battery limit conditions to cracking conditions. Once crossover temperature (inlet to radiant section) and coil outlet temperature are fixed for a feed with its corresponding hydrocarbon plus dilution steam flow rate, electrical duty in the radiant cell is almost known and fixed. Since outlet temperature of the preheater (same as cross over temperature) is fixed, minimum electrical duty is obtainable with possible maximum inlet temperature to the electric preheater.

With varying feeds and feed rates, within the limits of the electric preheater, the inlet temperature can be adjusted by adjusting the duty in equipment prior to the preheater.

In a first option, for a given feed, a secondary transfer line exchanger is in service for hydrocarbon heating. When a secondary transfer line exchanger is used, it will follow the primary transfer line exchanger. It will be designed such that tube-side is at least cleaned on-line. Typically, this requires secondary transfer line exchanger outlet temperature to be higher than 350° C. With light feeds like ethane or propane, shell side will contain hydrocarbon and hydrocarbon plus dilution steam mixture (assumed to be in the shell side of the exchanger). A minimum required inlet temperature will be provided. How this minimum is achieved is discussed later. Feeds like naphtha (low coking liquid feeds) vapor phase hydrocarbon plus dilution steam will be used in the shell side. A gain, proper heating will be done to get the proper inlet temperature. For such light feeds, the electric preheater can be bypassed if required. A feed like gasoil will foul and hence for such feeds only dilution steam will be used. A partial hydrocarbon plus dilution steam can also be used.

Gasoil/condensate feeds will be heated externally, preferably in exchangers (discussed later) and mixed with saturated or superheated dilution steam. The material boiling at low temperatures initially is a light low coking oil. The two-phase mixture is sent to a drum for vapor/liquid separation and the vapor is sent to secondary transfer line exchanger. At the outlet of secondary transfer line exchanger shell side, superheated hydrocarbon plus dilution steam mixture is blended with hot liquid obtained earlier and sent to electric heater or directly to the radiant cell since the temperature will be reasonably high. Note that dilution steam has low heat capacity. By mixing with some hydrocarbon the heat capacity is increased and heat recovery is high. That is the reason some and not all hydrocarbons is used in the gasoil case. Mainly tail end contains high concentration of coke precursors. If the crossover temperature is low, then an electric preheater is required. When only dilution steam is used for superheating then preheated heavy feed is mixed with superheated dilution steam and vaporized and sent to electric preheater. Only steam option can also be considered for any feed. But heat recovery will be low for ethane, propane and naphtha feeds when mixed (hydrocarbon plus dilution steam) can be used in the shell side.

In a second option described herein, akin to FIG. 3, no secondary transfer line exchanger is used. In this case, the primary transfer line exchanger is designed to extract as much heat as possible from the effluents. The feed mixture is preheated externally with other available streams and then sent to the electric preheater. Other stream preheating is discussed later. This generates the maximum amount of super high-pressure steam.

In another option described herein, hot oil is heated in a secondary transfer line exchanger. This option can be considered, but it is less preferable since shell side will see slightly increased coking form hot oil and is believed to be more expensive. Shell side uses hot oil like “DOWTHERM”, and these fluids can typically be used at temperatures up to 400° C. The flow rate will be adjusted in the shell side to extract heat whether cracker feed is ethane, naphtha, or gasoil. The hot fluid will go to a common storage. From there the individual feed ethane, propane, naphtha or gas oil is heated in a separate exchanger and vaporized with adding dilution steam. Note that at all times the secondary transfer line exchanger is a gas-liquid exchanger and hence heat transfer coefficient is high. In the external exchanger where naphtha or gas oil is preheated again it is liquid and liquid/gas exchanger. But maximum temperature achievable is about 400° C. limitation due to heat transfer fluid limitations. Any high temperature fluid can be used. In this example “DOWTHERM” is shown as an example only.

As discussed above, the secondary transfer line exchanger will accept only vapor feed in the shell side. Therefore, whether the cracker feed is ethane or naphtha or gasoil, it has to be vaporized before entering the secondary transfer line exchanger. When a secondary transfer line exchanger is used for heavy feeds only dilution steam can be heated. So hydrocarbon feed has to be preheated. For example, gasoil has to be preheated sufficiently externally in an exchanger with external fluid. These fluids can be hot oil heated in secondary transfer line exchanger or by other methods. It can also be low-pressure steam (less than 1 bar, typically), medium-pressure steam (0.5 bar to 3 bar, for example), high-pressure steam (greater than 1 bar up to 100 bar, for example) or even super high- pressure steam, saturated or superheated; while exemplary pressure ranges are provided, it is noted that these terms are well known in the industry. Note that some saturated super high-pressure steam is produced in the primary transfer line exchanger. Low temperature heating can be done with quench water, boiler feed water or by other hot fluids available in the plant. Further heating is done only by above steams. This will save some energy. The exchanger can be shell and tube or kettle type for vaporization. Un-vaporized or partly vaporized feed will be mixed with hot dilution steam (superheated in secondary transfer line exchanger) to get full vaporization and sent to the electric preheater. When superheated dilution steam is not produced in the secondary transfer line exchanger (for some cases discussed above), then only hydrocarbon will be preheated sufficiently, and saturated dilution steam will be added just to be sufficient to vaporize the hydrocarbon. This is possible for naphtha feeds and only partial vaporization can be expected for heavy feeds. Only vaporized feed is preheated in the secondary transfer line exchanger as discussed above. It is not advisable to send liquids (as two phase) to the shell side of the secondary transfer line exchanger, as it will coke the exchanger quickly. The separated liquid previously is again mixed with superheated vapor hydrocarbon plus dilution steam mixture from secondary transfer line exchanger and now the liquid is fully vaporized. Even if the vaporization is not complete it can still be sent to the electric preheater. That preheater can be designed for two phase mixtures like that used in a typical convection section including vaporization. For electric preheater, two phase mixture is acceptable. Saturation temperature of super high-pressure steam is 315-327° C. and hence most fluids can be heated to only around 300° C. With dilution added the final vaporization can be reduced to below 300° C. for most heavy feeds. Even if it is not fully vaporized, the electric preheater can be used to vaporize and superheat it to desired temperature.

The electric preheater used to achieve the desired crossover temperature is different from the radiant coil electric heater used for cracking. Though this heating can be incorporated with radiant coil, it will increase the radiant coil load and will limit the reactor performance. Often venturis are used to distribute the flows to individual (parallel) tubes in the radiant section. Two phase flow is not acceptable across venturis. When the inlet temperature is low, it may not be possible to decoke those tubes in a reasonable amount of time with steam/air. Therefore, any crossover temperature below 500° C. for any feed is not preferred for entry into radiant coil. Inlet passes of radiant coil are not designed for such cold temperatures. Higher and optimum temperature is preferred. Therefore, this can be achieved by an independent preheater as described herein. This preheater is different from radiant coil heater. The electric preheater can be one heater common for all coils. When each coil or heater has its own preheater, it can be mounted on top of radiant coil box, placed above the radiant section, or side by side with radiation protection (wall) so that heat input in regular radiant coil section does not affect this preheater. Preferably the electric crossover preheater is outside the radiant heater. By this way, sparing the preheater continuous service is available. This preheater (exchanger) has to be cleaned manually or special online decoking can be used. When a common preheater is used for many heaters, a spare preheater is preferred. The electric crossover preheater can be a convective type electric heater used in many refinery operations. It can be built like an exchanger where heating coils are inserted in the exchanger. Maximum process temperature in the electric preheater does not exceed 700° C. for any feed. For most feeds it will be around 600° C. Therefore, even if radiant heat transfer is used, metallic heating elements can be used. By carefully choosing the electrical system, both preheater and main radiant heater can share the same electrical system, but such is not required. The electric preheater may also be independent of main radiant heater. Outlet temperature of the electric preheater can be controlled independently. Where this is used for heating vapor phase at moderate temperatures it can be split into as many heaters or coils as required using control devices.

Note that the total electrical duty may not change much, but separating preheating from the main reactor electrical duty increases the control flexibility. Run length of reactor (radiant section) is usually limited by tube metal temperature or venturi margin. Preheater is not limited by tube metal temperature, and it will be cleaned based on pressure drop and/or excessive electrical duty due to reduction in heat transfer. By separating preheating as an electrical heater from the main radiant heater, the heater performance is highly improved. For changes in flow rate or severity and/or other operating conditions, the electric crossover preheater can be independently controlled to get about the same crossover temperature from start-of-run to end-of-run. For gasoil and other highly fouling feeds, this gives a tremendous advantage in heater performance, and capacity of the heater and plant can be maintained. When a secondary transfer line exchanger is not used, the produced super high-pressure steam is used for preheating the feed before entering the electric preheater. So even with significantly fouling feed, heater effluent energy is maximum utilized. By economical choice one can decide to use either a secondary transfer line exchanger or additional super high-pressure steam option. If super high-pressure steam is more valuable instead of using it as preheating duty source, separate electrical super high-pressure steam superheater can also be considered. This will increase the electrical load in the heater area, but super high-pressure steam be used for driving turbines in the recovery section.

In embodiments herein, with electrical preheater, only the heater area is modified to use electricity instead of fuel and the recovery section is similar to current fired heaters. The preheater can be placed on the top of the radiant section and does not require any extra space similar to current fired heater. Alternatively, it can be placed side to the radiant section. Instead of convective preheating one can consider radiant preheating also. If electrical radiant preheating is used, then it is put in separate cell or heater. For example, one cell will be used for preheating while the other cell will be used as radiant heated reactor. The preheated cell can supply more than one radiant heaters also. In this manner, the preheater is controlled independently. By the options described herein, electric heaters can be used for heavy feeds and are similar to light feeds and they reduce the overall electrical demand.

In the embodiment of FIG. 1 or FIG. 2, for example, instead of condensate any liquid from naphtha to heavy feeds can be used. Gaseous feeds can also be used but the exchanger have to be rated or redesigned for those cases, or some exchangers have to be bypassed.

Any hydrocarbon is first preheated with available heat source like quench water, low-pressure steam, or other hot streams in a first exchanger system including one or multiple exchangers, which may use the same or different hot sources running parallel or series. Under these conditions, the outlet of the liquid feeds will be still liquid or only partially vaporized. For all light feeds and gaseous feeds after mixing with dilution steam it will be completely vaporized or nearly fully vaporized. For this, dilution steam temperature and rate can be adjusted when possible. Otherwise, the next exchanger system sees mixed phase and has to be designed for mixed phase. A secondary transfer line exchanger is used to superheat the dilution steam as discussed above. The heating medium for the first exchanger system can be any level of steam including super high-pressure steam. For condensate and heavy feeds cracking, the secondary transfer line exchanger will be used to superheat dilution steam. For gaseous and light feeds, dilution steam will be mixed with the hot gas (or naphtha) after the first exchanger system and the mixture sent to secondary transfer line exchanger. Heat balance has to be checked and accordingly additional heating may need to be provided before entering the secondary transfer line exchanger. For some feeds the second heat exchange system can be bypassed, and the feed sent directly to the secondary transfer line exchanger for heating. For some cases outlet of the secondary transfer line exchanger (shell side) is at a sufficiently high temperature to go directly to the radiant coil, bypassing the electric preheater.

After mixing with dilution steam, the hydrocarbon feed is heated in the second exchanger system. This can be a single phase or two-phase exchanger. The hot fluid is usually high-pressure steam or super high-pressure steam and this is the highest temperature heating source available to be used in an exchanger. In some cases, hot fluid like DOWTHERM can be used. The maximum temperature is limited by the hot source temperature. For economic reasons, the maximum temperature out of the second exchanger system is 10-30° C. below the hot source temperature value. This temperature is much lower than desired as a crossover temperature. However, the outlet is mainly vapor phase (hydrocarbon plus dilution steam). By sending this stream directly to the electric heater (radiant cell) for olefin production produces high electrical load for radiant heater and gives poor performance. To prevent this, an electrical preheater is used in embodiments herein to preheat this mixture to desired cross over temperature. Generally, the electric crossover preheater is a convective heater. Both metallic or ceramic elements can be used. In some convective heaters the element is covered with anti-coking materials. A suitable electric element can be chosen for the required service. Heating elements can be immersed in the fluid if desired or heating gas can pass through (convective) the heating elements as required by the electrical heater manufacturer. In any case this is not a radiant type heater. As discussed above the control of this heater is different from radiant heater. The feed preheaters (first, second, and crossover) can be common for all cracking coils, and each can be spared for improved onstream factor if desired. They can also be built separately for each coil or each heater. When the electric crossover preheater is designed for a single coil or single heater it can be at the top of radiant section or adjacent to the radiant section. As an alternative way it can be a radiant heater also; while not preferred, it is acceptable. Even if it is heated by radiant mode, it can be for one or more coils. Without partition in the radiant section where reaction takes place, it is not recommended. High coking rate at inlet sections can be expected and can shorten the run length. By heating this in another cell or with partition, heat input can be controlled. Partition behaves like a dual cell. Less expensive convective heaters (exchanger types) are already in use for refinery process fluid heating and hence they are preferred.

Condensates cracking feed contains coke precursors, and in such embodiments akin to FIG. 1, a separation system is used to limit secondary transfer line exchanger fouling. Separations systems, such as a single stage flash, or a multiple stage separation such as a heavy oil processing scheme (HOPS, available from Lummus Technology LLC) may be used commercially. If flash or other similar systems are used, care should be taken such that carryover of liquid droplets should be minimized. The hydrocarbon feeds are heated through exchangers and additionally by electrical preheating in electrical heaters. Here, the condensate is preheated in different exchangers and partially vaporized condensate is mixed with dilution steam. The dilution steam can be saturated or superheated. This dilution steam can be added before or after each or both of the first exchanger system and the second exchanger system, such as where the feed is preheated with hot fluid like super high-pressure steam or hot oil. Partial or total dilution flow can be considered. The mixed stream (hydrocarbon plus dilution steam) enters a separator. Where this is a simple flash drum to separate the vapor liquid, some liquid distributor/demist pads can be included to minimize or eliminate liquid carry over in the gas stream. A liquid reflux is optional and may be used to further limit carryover of liquids. For this purpose, similar to reflux liquid condensate can be used. Reflux can also be obtained by condensing the vapor instead of using fresh feed. Thus, only the resulting vapor from the separator is superheated. If desired, the separated liquid may be combined with superheated vapor completing the vaporization externally to the secondary transfer line exchanger. By this method during vaporization no part is exposed to high temperature and hence coking is avoided. Some condensates have high concentration of coke precursors. They will not only coke the secondary transfer line exchanger shell side but also the radiant coil. It is better not to crack those portions. Those coke precursors are often concentrated in the tail end of the boiling curve. Separating the last boiling liquid, the liquid can be mixed with superheated vapor or discarded (not cracked). Suitably designing the exchanger systems and separator, coke deposition in those units can be avoided and in addition, these units are operating at low temperature. Vapor going to the secondary transfer line exchanger is nearly free of those coke precursors. Using demister and reflux minimizes the entrainment of coke precursors in the gas phase. As a result, many condensate feeds can be cracked in systems described herein. The vapor then goes to the electric preheater and then to the radiant cell.

In some embodiments, akin to FIG. 3, there is no secondary transfer line exchanger. This option can be used for all gaseous and liquid feeds. But it is preferred for heavy feeds where only dilution steam can be used for heating in secondary transfer line exchanger when used and also there is no vapor liquid separator. Here the primary transfer line exchanger generates super high-pressure steam. After preliminary heating the hydrocarbon in one or more exchangers, dilution steam is injected, and the mixture is heated in a second exchanger system. In all these heating steps, super high-pressure steam may be used, and it can be saturated or superheated. Additional super high-pressure steam (or total super high-pressure steam) is superheated in a different electric heater and sent to super high-pressure header. The advantage is there is no secondary transfer line exchanger and is similar to current conventional (gas-fired) heater. All the heating is done by locally available hot fluids and super high-pressure steam. Additional duty is supplied by the electric preheater. The exchangers can be by passed or super high-pressure steam can be controlled to preheat the process fluid. The electric preheater system delivers the required inlet temperature to the radiant coil. By controlling the heat inputs, constant and predetermined cross over temperature can be obtained for all feeds and maximum benefit of electric radiant coil is obtained. However, this requires maximum electrical duty. Working hot fluid is super high-pressure steam and hence some exchangers have to be designed for high pressures. A gain, each heating system can be designed for a single coil, or for a group of coils and/or for a group of heaters. All these units can be spared for high onstream time and reliability.

In all the above embodiments, both primary and secondary transfer line exchanger will be on-line cleaned. Depending upon the preheater design, the electric preheater can also be cleaned. There is only one side (process side) and the other side is heating elements. Economical choice will dictate sparing and design philosophy.

As described above, embodiments herein provide for improved and consistent performance of cracking heaters from start-of-run to end-of-run. Heating of hydrocarbon feedstocks via available heat sources such as steam or other fluids followed by use of an electric heater to bring the feedstock up to a desired steady state crossover temperature also provides for minimizing the radiant electrical duty, thus allowing for the design of electrical supply systems to be more optimal, less complex, and at a reduced capital cost, comparatively to systems without a crossover preheater.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non- limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

Exchangers in the figures may be illustrated as having a shell-side or tube-side service associated with a particular stream. The illustration is for exemplary purposes only, and either stream may be associated with the shell-side or tube-side, as may be appropriate to the feed and service type.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed as new and desired to be protected by Letters Patent is:

1. A process for converting a hydrocarbon mixture to produce olefins, the process comprising:
preheating a hydrocarbon feed in one or multiple preheaters to a preheat temperature, producing a preheated hydrocarbon stream;
separating the preheated hydrocarbon stream in one or more separation systems, producing a vaporized hydrocarbon stream and a liquid hydrocarbon stream;
heating the vaporized hydrocarbon stream in a secondary transfer line exchanger, producing a heated hydrocarbon stream;
heating the heated hydrocarbon stream in a convective electric preheater, producing a second heated hydrocarbon stream;
cracking the second heated hydrocarbon stream using a radiant electric thermal cracking heater, producing a cracked hydrocarbon product stream; and
feeding the cracked hydrocarbon product stream to a primary transfer line exchanger for quenching the cracked hydrocarbon product stream and recovering a cooled hydrocarbon product stream; and
feeding the cooled hydrocarbon product stream to the secondary transfer line exchanger, producing a hydrocarbon product stream.

2. The process of claim 1, further comprising mixing one or multiple of the hydrocarbon feed, the preheated hydrocarbon stream, the heated hydrocarbon stream, and the second heated hydrocarbon stream with dilution steam.

3. The process of claim 1, wherein
the preheating increases a temperature of the hydrocarbon feed producing a preheated hydrocarbon stream having a temperature in a range from 280° C. to 330° C.;
the heating in the secondary transferline exchanger increases a temperature of the vaporized hydrocarbon stream producing a heated hydrocarbon stream having a temperature in a range from 350° C. to 500° C.; and
the heating in the convective electric preheater increases a temperature of the heated hydrocarbon stream producing a second heated hydrocarbon stream having a temperature in a range from 570° C. to 700° C.

4. The process of claim 1, comprising controlling a temperature of the second heated hydrocarbon stream produced in the convective electric heater to a steady state crossover temperature.

5. A process for converting a hydrocarbon mixture to produce olefins, the process comprising:
preheating a hydrocarbon feed [via indirect heat exchange with boiler feed water, steam, or other sources of heat located in the plant] in one or multiple first preheaters to a preheat temperature, producing a preheated hydrocarbon stream;
mixing the preheated hydrocarbon stream with dilution steam to produce a mixture;
heating the mixture in one or multiple second preheaters, producing a heated hydrocarbon-steam mixture;
heating the heated hydrocarbon-steam mixture in a convective electric preheater, producing a second heated hydrocarbon stream;
cracking the second heated hydrocarbon stream using a radiant electric thermal cracking heater, producing a cracked hydrocarbon product stream; and
feeding the cracked hydrocarbon product stream to a primary transfer line exchanger for quenching the cracked hydrocarbon product stream and recovering a cooled hydrocarbon product stream.

6. The process of claim 5, further comprising feeding the cooled hydrocarbon product stream to a secondary transfer line exchanger, producing a hydrocarbon product stream.

7. The process of claim 5, further comprising mixing one or multiple of the hydrocarbon feed, the preheated hydrocarbon stream, the mixture, the heated hydrocarbon-steam mixture, and the second heated hydrocarbon stream with dilution steam.

8. The process of claim 7, further comprising producing the dilution steam in one or both of the primary transfer line exchanger and the secondary transfer line exchanger.

9. The process of claim 7, further comprising producing super high-pressure steam in an electric heater and using the super high pressure steam as dilution steam.

10. A system for converting a hydrocarbon mixture to produce olefins, the process comprising:
a first preheat system comprising one or multiple preheaters configured to receive and preheat a hydrocarbon feed to a preheat temperature, producing a preheated hydrocarbon stream;
a separation system for separating the preheated hydrocarbon stream to recover a vaporized hydrocarbon stream and a liquid hydrocarbon stream;
a secondary transfer line exchanger for heating the vaporized hydrocarbon stream to produce a heated hydrocarbon stream;
a convective electric preheater for heating the heated hydrocarbon stream to produce a second heated hydrocarbon stream;
a radiant electric thermal cracking heater for heating and cracking the second heated hydrocarbon stream to produce a cracked hydrocarbon product stream;
a primary transfer line exchanger for quenching the cracked hydrocarbon product stream to recover a cooled hydrocarbon product stream; and
a flow line feeding the cooled hydrocarbon product stream to the secondary transfer line exchanger, producing a hydrocarbon product stream.

11. The system of claim 10, further comprising flow lines for mixing one or multiple of the hydrocarbon feed, the preheated hydrocarbon stream, the heated hydrocarbon stream, and the second heated hydrocarbon stream with dilution steam.

12. The system of claim 11, wherein
the first preheat system is configured for increasing a temperature of the hydrocarbon feed to a temperature in a range from 280° C. to 330° C.;
the secondary transferline exchanger is configured to increase a temperature of the vaporized hydrocarbon stream to a temperature in a range from 350° C. to 500° C.; and
the convective electric preheater is configured to increase a temperature of the heated hydrocarbon stream to a temperature in a range from 570° C. to 700° C.

13. A system for converting a hydrocarbon mixture to produce olefins, the process comprising:
a first preheat exchanger system comprising one or multiple heat exchangers to heat a hydrocarbon feedstock to a preheat temperature, producing a preheated hydrocarbon stream;
one or more flow lines for mixing the preheated hydrocarbon stream with dilution steam to produce a mixture;
a second preheat exchanger system comprising one or multiple heat exchangers to heat the mixture, producing a heated hydrocarbon-steam mixture;
a convective electric preheater for heating the heated hydrocarbon-steam mixture, producing a second heated hydrocarbon stream;
a radiant electric thermal cracking heater for cracking the second heated hydrocarbon stream, producing a cracked hydrocarbon product stream; and
a primary transfer line exchanger for quenching the cracked hydrocarbon product stream and recovering a cooled hydrocarbon product stream.

14. The system of claim 13, further comprising a secondary transfer line exchanger for further cooling the cooled hydrocarbon product stream.

15. The system of claim 13, further comprising flow lines for mixing one or multiple of the hydrocarbon feed, the preheated hydrocarbon stream, the mixture, the heated hydrocarbon-steam mixture, and the second heated hydrocarbon stream with dilution steam.

16. The process of claim 13, further comprising an electric heater for producing super high-pressure steam and flow lines for distributing the super high pressure steam as dilution steam.
